(19) United States
(12) Patent Application Publication
(10) Pub. No.: US 2009/0300474 A1
(43) Pub. Date: Dec. 3, 2009

(54) Computer-based architecture using remotely-controlled electronic grid-based calculators

(75) Inventors: Paul M. Asplund, Hoffman Estates, IL (US); Michael A.X. Izatt, Wheaton, IL (US)

Correspondence Address: CentraLytics, Inc. (c/o Matthew O. Brady, Esq.), The Chicago Mercantile Exchange, 30 South Wacker Drive, Suite 2200, Chicago, IL, 60606, US

(73) Assignee: CentraLytics, Inc., Chicago, IL (US)

(21) Appl. No.: 12/455,166

(22) Filed: May 29, 2009

Related U.S. Application Data
(60) Provisional application No. 61/130,217, filed on May 29, 2008.

(51) Int. Cl. G06F 17/00

(52) U.S. Cl. 715/213

(57) ABSTRACT

The present invention comprises a centrally-maintained electronic grid-based calculator and requisite service-oriented architecture to expose the calculator's computational facilities as a service to remote users. Furthermore, the present invention provides a server-side automation architecture of the electronic grid-based calculator which facilitates the distribution of intellectual capital throughout the business enterprise while providing real-time collection, analysis, and reporting of each distributed calculator while facilitating data production, data concurrency, data validation, data security, version control, audit trail, centralized reporting, internal control, quality control, computation, editing and communication.

### CROSS-REFERENCE TO RELATED APPLICATION

This application claims priority to U.S. Provisional Application Ser. No. 61/130,217, filed May 29, 2008.

### FIELD OF THE INVENTION

The present invention comprises a centrally-maintained electronic grid-based calculator and requisite service-oriented architecture to expose the calculator's computational facilities as a service to remote users. Furthermore, the present invention provides a server-side automation architecture of the electronic grid-based calculator which facilitates the distribution of intellectual capital throughout the business enterprise while providing real-time collection, analysis, and reporting of each distributed calculator while facilitating data production, data concurrency, data validation, data security, version control, audit trail, centralized reporting, internal control, quality control, computation, editing and communication.

### BACKGROUND OF THE INVENTION

Electronic grid-based calculators, hereinafter referred to as “spreadsheets,” are vital to the success of nearly every business. Spreadsheets are pervasive in the business enterprise because they provide a portable, nimble, capable work productivity tool with which to analyze and inform executive decisions, meet managerial and regulatory obligations, and model business processes and other quantitative scenarios.

Spreadsheets contain various artifacts that constitute material, non-public information. For example, a spreadsheet contains proprietary data input and reference data, the privacy of which is integral to the business firm's capability to compete effectively and efficiently in the marketplace. Further, the formulae in a spreadsheet comprise important business intelligence. Such formulae often contain important quantitative constants such as interest, discount, effective tax rates, cost ratios and engineering or scientific constants that are proprietary and unique to the business firm. Finally, spreadsheets constitute a sophisticated and nimble data analysis tool, the reports from which are material, non-public intellectual capital for the business enterprise. Taken together, these spreadsheet artifacts constitute valuable, proprietary intellectual capital.

Benefits notwithstanding, spreadsheets suffer because the spreadsheet intellectual capital (whether a business computation, data, formulae, simulation, or financial model) is not scalable; that is, the business logic encapsulated in a spreadsheet is not accessible by a user not in possession of an electronic copy of the spreadsheet.

Various approaches have been proposed to allow stakeholders to collaborate between and among each other with respect to spreadsheet intellectual capital. Typically, the spreadsheet is transmitted between and among stakeholders via electronic mail, shared network computer drives, or file-transfer protocol (FTP) servers. Recently, Internet-based solutions have been presented. So-called “collaboration servers” provide a centralized location on the Internet where stakeholders can download spreadsheet models, undertake analysis to update and improve the model, and upload the incremental solution back to the collaboration server.

In general, configuration of a collaboration server requires the professional and learned skills of an information technology professional. The total cost of establishing and maintaining the collaboration server (including server licenses, network overhead costs, and payroll for the information technology professionals) is much greater than the cost of the spreadsheet itself The putative utility of this solution is belied by the fact that the spreadsheet itself contains and encapsulates the entire business solution, and the expensive collaboration server solution, while providing access between and among users, does nothing to enhance the spreadsheet intellectual capital originally rendered by the firm's analysts.

This is a significant concern since nearly 100% of business intelligence is contained in spreadsheets; that is: 1) spreadsheets and spreadsheet-based applications, models and simulations are often the original point of analysis for business intelligence within, between and among the many functional areas of business, and 2) spreadsheets are the typical media for analysis of data that is extracted, exported, or downloaded from enterprise resource planning (ERP) systems.

In the former case, the spreadsheet is the point of original data collection, analysis, distillation and reporting. The subject-matter expert (SME) undertakes sophisticated industry analysis in a functional area of business and applies the art of personal computing to arrive at insight, which is often tendered as spreadsheet-based work product. Whether the topical matter is accountancy, taxation, finance, human resources, engineering, architecture, business administration or law, the spreadsheet is a common, preferred, pervasive touch point for the user. The spreadsheet encapsulates valuable, material, non-public analysis that is the intellectual capital of the analyst's business, and is, indeed, the original source of that intellectual capital.

In the latter case, a spreadsheet provides the media in which an analyst consumes enterprise data. In this scenario, an ERP system captures the business firm's voluminous transactional data, and provides the computational power to condense and present the transactional data in various hierarchal ways, for example, by product code, division, geography, or human-resource level. However, notwithstanding the computational power of the ERP, data-warehousing or business-intelligence system to capture, distill, or present voluminous enterprise data, these tools are deficient in at least two (2) respects: a) they are not sufficiently nimble to accommodate sophisticated expert analysis in a functional area of business without the costly assistance of a systems analyst, and b) enterprise systems must be configured, programmed, maintained, updated, and installed by professional information technology professionals. Each of these two factors serves to decrease the quality and time-to-impact of subject-matter analysis that is available with a spreadsheet or spreadsheet-based model, application or simulation in the hands of a subject-matter expert in a functional area of business.

When deciding how best to transmit data between and among correspondents, many factors must be considered, including security, version control, data validation, and centralized reporting. Conventional practice is that spreadsheets crisscross the organization via electronic mail, corporate FTP site, or dedicated shared network directory. This is common practice, but is disadvantageous for four (4) reasons: 1) Distributing spreadsheet intellectual capital through these channels exposes the material, non-public information contained therein to unauthorized access by malicious actors both within and outside the business firm; 2) the centralized source cannot control the content and format of the spreadsheet intellectual capital in the hands of selected users once it is distributed throughout the enterprise; 3) selected users in receipt of spreadsheet intellectual capital are at liberty to change standard report formats, which confounds the centralized source's ability to create consolidated reports; and 4) the centralized source cannot effectively update the spreadsheet's values, formulae or lookup data once the intellectual capital is transmitted to the several selected users.

First, despite the ubiquitous presence of spreadsheets throughout the enterprise and the utility of spreadsheets for undertaking business analysis, the ease with which spreadsheet intellectual capital can be intercepted and misappropriated by a malicious actor either while the spreadsheet is at rest on a computer storage device or while in transit over a corporate network or internet creates an information-security risk in the enterprise. Various regulatory frameworks require that critical information be protected by an industrial-grade information security model. For example, the Health Insurance Portability and Accountability Act (HIPAA), the Gramm-Leach-Bliley Act (GLBA), and the internal-control provisions of the Sarbanes-Oxley Act of 2002 all address information security governance of material, non-public information. In the context of these provisions, intellectual capital contained in spreadsheets may not satisfy requirements of a comprehensive information security model. Furthermore, spreadsheets implement a weak security protocol, and do so in a way that exposes the protocol to attack, exposing the intellectual capital therein to attack from malicious outsiders and insiders alike, as well as unauthorized consumption by parties who may not have the proper status to receive data and information on the basis of organizational affiliation, geography, title, or responsibility within the enterprise. For example, Excel® 2003 (distributed by Microsoft Corporation of Redmond, Wash.) implements the RC4 stream cipher with up to 128-bit encryption. In 2005, a Chinese academic determined that Microsoft's implementation of this protocol suffered a critical flaw that could allow a user with basic cryptographic skills to decrypt Excel® files. Excel® 2003 maintains the same initialization vector across multiple versions of the same password-protected document. Therefore, a user who distributes an encrypted Excel spreadsheet, then subsequently updates or modifies the same spreadsheet before redistributing the updated and encrypted spreadsheet, will expose the Excel spreadsheet to differential cryptanalysis if the Excel spreadsheet is protected with the same password both at original distribution and subsequent redistribution. Unfortunately, this is standard practice in industry.

Secondly, once a centralized source distributes spreadsheet intellectual capital to selected users, the centralized source loses sovereignty over the spreadsheet, and the selected users may change data, formula, programming, and reference data within the spreadsheet. As depicted in FIG. 1, a centralized source 101 creates or provides intellectual capital within a master spreadsheet 102 and transmits or transports 110, 111, 112 a copy of that master spreadsheet to selected users 121, 131, 141 (such as, for example, employees of the centralized source organization who may work in a branch office) via electronic mail, the Internet, a company Intranet, collaboration server, or shared network drive. The selected users insert data and immediately obtain calculated output associated with the previously inserted data 122, 132, 142.

Within the context of normal usage of spreadsheet intellectual capital, each of the distributed copies of the master spreadsheet contains the formulae, data entries, models, pricing engines, calculations, and other material non-public information of the business firm. Furthermore, each of the selected users is at liberty to change his/her copy of the master spreadsheet formulae or lookup data, thereby causing each copy of the master spreadsheet to render a different calculation of the others, even for identical inputs. For example, FIG. 1 shows that the centralized source 101 created spreadsheet intellectual capital 102 with Interest Rate “I” of five percent (5%), Discount Rate “D” of four percent (4%), Effective Tax Rate “T” of twenty percent (20%) and Report Format “A,” 103 which is considered authoritative for the distributed workgroup. FIG. 1 further demonstrates that Selected User #1 121 unilaterally changes the Interest Rate “I” from an authoritative value of five percent (5%) to the value seven percent (7%) 122 and unilaterally crafts Report Format B 123, which differs from authoritative Report Format A 103. Selected User #2 131 unilaterally changes the Discount Rage “D” from an authoritative value of four percent (4%) to the value six percent (6%) 132 and unilaterally crafts Report Format C 133, which differs from authoritative Report Format A 103. Finally, Selected User #3 141 unilaterally changes the Effective Tax Rate “T” from an authoritative value of twenty percent (20%) to the value thirty percent (30%) 142 and unilaterally crafts Report Format A+B 143 which differs from authoritative Report Format A 103. The centralized source has no way to audit the distributed master spreadsheet's many results 122, 132, 142 and no way to ensure that the reports generated after data insertion of user input is accurate 123, 133, 143. Additionally, the centralized source has no way to assemble reliable, accurate, timely centralized reports based on the distributed master spreadsheet calculations.

Third, and as described in the discussion of FIG. 1 above, once spreadsheet intellectual capital is distributed throughout the enterprise to one or many selected users, those users are at liberty to change standard, authoritative report formats within the spreadsheet. Once these non-standard reports are transmitted back to the centralized source, the source must undertake a difficult consolidation exercise to retrieve meaningful business intelligence.

FIG. 2 shows that in an effort to create centralized reports, and in accordance with another accepted workflow within standard spreadsheet usage, the centralized source 201 creates the master spreadsheet 202 with authoritative Report format “A” 203 is transmitted 210 to selected users 220, 230, 240. After receipt of the distributed, master spreadsheet, the selected users are able to enter data 221, 231, 241 into one or more of the input cells on the distributed spreadsheet in accordance with the usage described in FIG. 1. Likewise, the selected users are able to unilaterally craft Reports 222, 232, 242 that differ from the authoritative Format A 203. The selected users then transmit 250 their respective copy of the distributed master spreadsheet via email or otherwise, back to the centralized source. After receipt of the distributed spreadsheets and Reports, which contains input data from the selected users, the centralized source can compile data 270 from the many received master spreadsheets 260 (=222, 232, 242) into a master Report Format A* (“A star”) 280, which is in the format of Report A 203, but which constitutes a compilation of Reports 260, each of which represents compilations of data from spreadsheets 221, 231, and 241, respectively. Report A* 280 is then distributed to the selected users and management. Although this method of standard usage 200 allows a centralized report, the centralized source is burdened by having to receive the data 260 from the selected users and collect and compile 270 the same into the master report. Furthermore, because the selected users unilaterally change data in their respective copies if the master spreadsheet 221, 231, 241, and transmit Reports 222, 232, 242, the centralized source's compilation produces not Report A 203 but rather Report A* 280.

Fourth, spreadsheet intellectual capital such as applications, models and simulations contain material, non-public, mission-critical information that can change for a variety of reasons. For example, a reduced effective tax rate or tax holiday may be negotiated in one or more jurisdictions; interest and discount factors change over time, sometimes within seconds, as the firm's cost-of-capital is adjusted for prevailing credit-market conditions; federal, state, provincial, and local income and transactional tax rules can change via regulation, legislation or negotiation with competent authority; parameters and constants across the many financial, scientific, engineering, medical, architectural, or pharmacological disciplines can be adjusted on a critical time scale; or labor costs, raw materials, and allocated overhead can fluctuate across markets, products, and production demographics. Each of these scenarios contemplates the change of a parameter that is easily adjusted in a spreadsheet model, but would require significantly more effort to adjust in a typical enterprise application.

The act of centrally maintaining a spreadsheet model comprising any or all of the above information, then modifying, updating, transmitting and distributing it can be insecure, inaccurate, untimely, and risky. In addition, if a material change is propagated through a centrally maintained spreadsheet by the spreadsheet's stakeholder/owner, no effective method exists to ensure that the entire user base both receives and uses the authoritative version and its concomitant business rules, reference data, and parameters. Users operating a superseded version of the spreadsheet undertake analysis with risk of developing incorrect information, reaching uninformed conclusions, and executing incorrect business decisions.

Two (2) alternatives exist for providing secure intellectual capital models to Users who are situated throughout a large enterprise: i) Traditional N-tier software architecture where information technology professionals study the spreadsheet intellectual capital and reverse engineer a spreadsheet model to render its functionality to a custom software application; and ii) the present invention, which seamlessly mounts the spreadsheet model itself on the enterprise technology harness. The present invention provides enhanced information security for spreadsheet intellectual capital. The present invention implements a public key infrastructure (PKI) to provide end-to-end, asymmetric cryptography that protects spreadsheet intellectual capital when at rest on the local hard disk, at rest on a remote server, or in motion on the local area network, Intranet, or Internet.

The process of reverse-engineering the spreadsheet intellectual capital to the N-tier architecture renders the data, formulae, business rules, reference data and reports therein to a multi-tier custom software application, which generally utilizes a graphical user interface (GUI) that exposes the application's functions and features to the user; software middleware that contains the applications' business rules and logic; and database operational data storage that provides persistence for the application's data within, between and among User sessions.

In this process, a team of information technology professionals (often comprising business analysts, systems analysts, database engineers, software engineers, and programmers) commence a software development life cycle (SDLC) during which the team members will undertake business modeling, requirements gathering, analysis, design, implementation, test and deployment activities, most often in an iterative manner, with the goal to replicate the spreadsheet's functionality in an N-tier software application.

From the point of view of the spreadsheet User, the enterprise's investment in the custom software application, measured as the time and charges incurred by the information technology professionals during the execution of the software development life cycle time line, represents a dead-weight loss during which time the business solution in the form of the spreadsheet intellectual capital was discontinued in anticipation of the delivery of the custom software application.

Therefore, a solution to reduce the opportunity cost of engaging an information technology integration team to reverse engineer functionality that is already encapsulated by the business subject-matter expert in the spreadsheet itself is widely needed. Additionally, the development of N-tier applications based on source authoritative spreadsheet intellectual capital requires the business subject-matter expert to surrender control of the intellectual capital and completely migrate the spreadsheet business solution to an N-tier technology solution that rarely replicates the nimble, fluid nature of spreadsheet analysis. Furthermore, the primary steward of the N-tier technology solution then becomes the information technology professional rather than the subject-matter stakeholder such as the accounting, tax, engineering, or financial expert who was the executive steward and author of the spreadsheet business solution and who is adept at spreadsheet modeling within his/her chosen profession. The present invention provides solutions to each of these problems.

Notwithstanding the disadvantages of surrendering spreadsheet intellectual capital to the software development life cycle, this path is generally considered the first option because it is the process most familiar to internal information technology departments and outside consultants. The spreadsheet's stakeholder wishes to scale the spreadsheet solution to obtain such attributes as version control, concurrency, and information security, and requests the IT department to provide a technology solution to the business problem. IT knows enterprise software and server configuration, and generally directs stakeholders in that direction even through for all but the most elite problems, an enterprise solution is more costly and contains much more scope than the requirements dictate.

Creating the N-tier application generally starts with the stakeholder explaining the many sophisticated, subtle, and fluid business rules and processes of the business to the information technology consultant. This exercise is part of the requirements-gathering task of a typical software development life cycle. Such requirements gathering and the concomitant business analysis required to understand, interpret and transform the requirements to operational software development tasks, serve to teach the IT consultant how to design the enterprise technology solution to deliver the correct business answer that was already available in the spreadsheet model before it was submitted to the software development life cycle.

Once the information technology consultants achieve an understanding of the business, a comprehensive project plan is developed. Specifically, the development life cycle includes the initial step of defining the business requirements, followed by a three-tiered approach to meeting the business needs. The first tier includes designing the technical architecture and selecting and installing the relevant products. Concurrently, the second tier (including dimensional data modeling and mapping) is underway. Following the second tier, the physical product and data staging products are designed and developed. The third tier includes the specification and development of the end-user application. Finally, the solution is deployed after which it is maintained and grown to meet further needs.

After achieving an understanding of the various aspects of the business problem and the requested technology solution, the IT consultants enter the software development life cycle to realize the comprehensive project plan. A software development life cycle must articulate coordinated work flows for the requisite disciplines that support software engineering and development. Previous industry convention was to plan and coordinate a software project sufficiently well that engineering could proceed in lock step from inception to delivery—a so-called “cascading” life cycle. Modern life cycle models recognize that these work flows occur in a repetitive manner throughout subsequent phases of a software development project to account for theretofore unforeseen or unforeseeable requirements, engineering approaches, or features—a so-called “iterative” life cycle.

The non-spreadsheet, enterprise N-tier application developed by the IT department is expensive, resource-intensive, lengthy in implementation, has a poor cost/benefit ratio, small return-on-investment, and takes an astonishingly long time to create and release to production compared to the time scale of the spreadsheet-based solution. Furthermore, once this time and expense is incurred and the enterprise N-tier application is implemented, no additional business insight is delivered to the end user over and above that provided by the spreadsheet tool.

In any case, for a large class of front-line and back-office business analysis problems, enterprise information technology engineering is infeasible due to the difficulty of implementing erudite business rules or use cases within custom software and database solutions. More importantly, the enterprise information technology approach causes the front-line subject-matter expert to lose sovereignty of the spreadsheet intellectual capital. All future changes to the model, even modest ones such as a small change in a parameter, must be accomplished via standard internal change orders (which can take a lengthy amount of time in a larger organization) and everything is generally implemented in custom code by the consultants or central information technology department. Generally, these issues are only discovered after time, resources, and money have already been invested.

An alternative to this timely, costly, ineffective approach is needed that provides an intellectual capital model that seamlessly mounts a spreadsheet into the existing information technology harness and allows stakeholders to maintain control over the spreadsheet intellectual capital model and distribute relevant information as needed.

Microsoft has contended that various problems can be encountered when exposing spreadsheet services to remote users. For example, Microsoft indicates that server-side automation of its Office products is not recommended and not supported for various reasons, including unstable behavior and/or deadlock. Microsoft further notes that various problems may be encountered during server-side automation such as unknown user identity, faulty interaction with the desktop and server, reentrancy, scalability, resiliency, stability, and security. The present invention provides a solution for each of these putative problems.

This alternative hints at the need for a new spreadsheet middleware paradigm that allows a remote User to consume the spreadsheet intellectual capital as it sits on a central server. This new paradigm is the subject of the present invention, which provides the server infrastructure, service-oriented architecture, naming standards, coding standards, and software development life cycle methodology to enable remote Users to consume spreadsheet intellectual capital from a central location. Furthermore, the present invention empowers front-line subject-matter experts to use the spreadsheet as the primary software application design platform, and thereby retain sovereignty of the spreadsheet intellectual capital that would otherwise be surrendered to central information technology for rendering to enterprise software development tools. By keeping sovereignty of the spreadsheet with the business subject-matter expert, the present invention provides the technology harness to drastically shrink required development costs, maintenance, time-to-impact, and total cost of ownership.

### BRIEF SUMMARY OF THE INVENTION

The present invention relates to a computer-based architecture comprising a centrally-maintained electronic grid-based calculator and means to ensure secure data production, editing, communication and reporting in order to meet various business needs. The present invention comprises a centrally-maintained electronic grid-based calculator and requisite service-oriented architecture to expose the calculator's computational facilities as a service to remote users and the means to undertake remote method invocation and remotely consume computational services from the grid-based calculator and ensures Furthermore, the present invention provides a server-side automation architecture of the electronic grid-based calculator which facilitates the distribution of intellectual capital throughout the business enterprise while providing real-time collection, analysis, and reporting of each distributed calculator while facilitating data production, data concurrency, data validation, data security, version control, audit trail, centralized reporting, internal control, quality control, computation, editing and communication.

### BRIEF DESCRIPTION OF THE DRAWINGS

The foregoing and other advantages of the invention will become apparent upon reading the following detailed description and upon reference to the drawings in which:

FIG. 1 is a flow diagram depicting one version of a computer-based architecture without remotely-controlled electronic grid-based calculators.

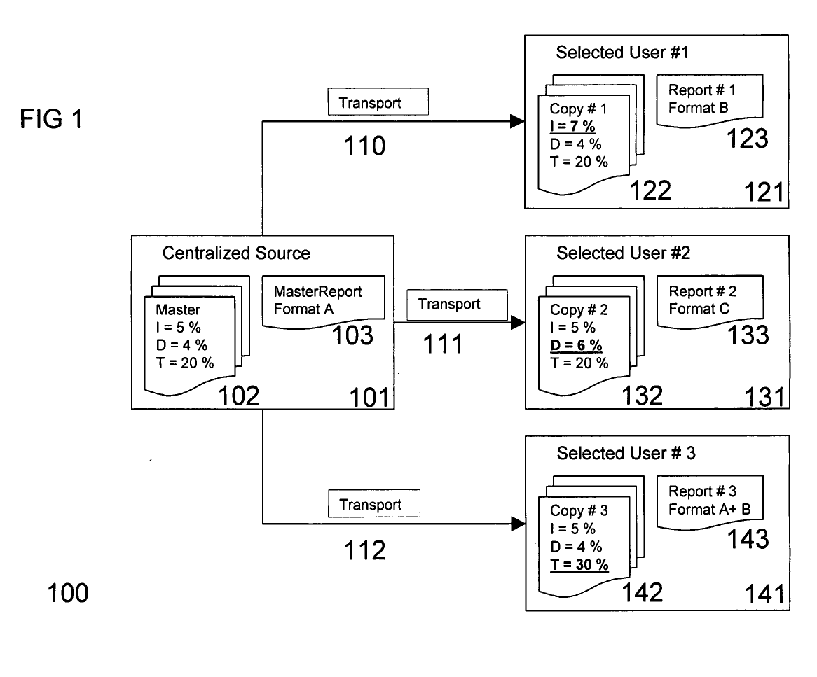

FIG. 2 is a flow diagram depicting a second version of a computer-based architecture without remotely-controlled electronic grid-based calculators.

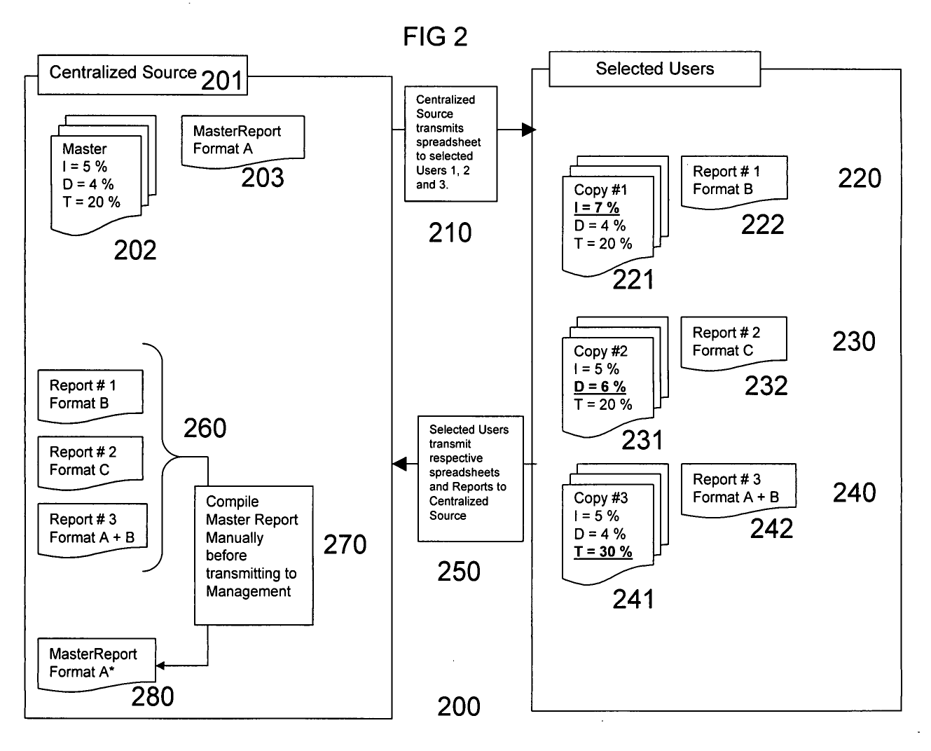

FIG. 3 is a flow diagram depicting a typical spreadsheet application.

FIG. 4 is a flow diagram depicting the remotely-controlled computer-based architecture of the present invention.

FIG. 5 is flow diagram depicting a sales transaction using the computer-based architecture of the present invention.

While the invention is susceptible to various modifications and alternative forms, specific embodiments have been shown by way of illustrative example in the drawings and will be described in detail herein. However, it should be understood that the invention is not intended to be limited to the particular forms disclosed herein. Rather, the invention is to cover all modifications, equivalents, and alternatives falling within the spirit and scope of the invention as defined by the appended claims.

### DETAILED DESCRIPTION OF THE INVENTION

A robust enterprise computer information system provides one or more or preferably all of the following attributes:

The system separates the User Interface, business logic, and data storage media;

Information is secure while in transit across the computer network, Intranet, or Internet;

Information remains secure while at rest on the local or remote disk drive;

The total cost of ownership, comprising costs to both design and maintain the system, are low;

Changes to the system can be implemented quickly, efficiently, effectively, and affordably;

Business logic, business rules, analysis, and reporting can be crafted by the business subject matter expert directly without support from information-technology professional;

The system provides data warehousing capability easily without costly systems analysis;

The system provides business intelligence and ad-hoc query capability without costly systems analysis;

The system can be installed, deployed, distributed and accessed easily;

The system is intuitive to the business subject matter expert who is best able to encode business rules to be used by the system; and

The system seamlessly integrates into a knowledge workers' normal workflows

The present invention provides a robust approach to achieving each of these desirable attributes by presenting a computer-based information architecture that utilizes a spreadsheet as the primary medium to design, develop, distribute, consume, and analyze data in an N-tier Intra- or Internet-based application. The present invention places powerful technology in the hands of the business knowledge worker who, as a spreadsheet user and business subject-matter expert, is best capable of encoding business logic, business rules, data, and analysis in the spreadsheet. The present invention returns significant value to the business stakeholder in the form of drastically-reduced total cost-of-ownership and time-to-impact compared with extant and typical software development life cycle methodology that requires a business stakeholder (as the subject-matter expert in the business problem) to brief an information technology professional who (as the primary stakeholder in the technology solution) must undertake the time-consuming and costly exercise to build the business solution in extant enterprise technology tools. The present invention leverages the business stakeholder's investment in spreadsheets, applications, models and simulations and renders them immediately to the enterprise technology harness.

The centrally-managed and service-oriented architecture of the present invention allows various business groups the ability to leverage their investment in electronic spreadsheet models and mount them to a technology harness to achieve various benefits of enterprise information technology, including version control, data concurrency, audit trail, centralized reporting, data validation, internal control, data security, quality control, and many others with applications to decision support, business intelligence, data warehousing, and regulatory compliance. By contrast to the commonly-utilized N-Tier Architecture approaches that are comparatively expensive, inflexible and time-consuming, the present invention does not require an extensive project plan, is not overly expensive, and does not require large amounts of resources or a lengthy timeline. It requires few steps, takes less time and costs less than other alternatives. Furthermore, the present invention allows enterprise development to be undertaken by a business subject-matter expert.

For example, the architecture of the present invention allows and empowers spreadsheet intellectual capital to be leveraged within an enterprise information technology framework. Further, the present invention optionally provides IT professionals with server technology that enables the use of spreadsheet models as part of the overall operational and business intelligence capacity. The architecture of the present invention applies a rigorous end-to-end information security model and is ideal for bringing a spreadsheet-based tool and its proprietary data content into compliance with information-security provisions of various regulatory frameworks. In addition, real-time information storage (without limitations) and retrieval are provided, features that are unavailable with stand-alone or distributed spreadsheet models.

Additionally, the architecture of the present invention does not require the frontline user to educate a information-technology professional on the model's processes and business rules in order to create an enterprise-wide solution. More importantly, spreadsheet intellectual capital users maintain control and still have the original spreadsheet intellectual capital model that will be maintained by those very same experts. As set forth in greater detail below, the intellectual capital contained on a master spreadsheet becomes the calculation engine for the architecture of the present invention; therefore, if the master spreadsheet produces the proper results, the results on the resulting user spreadsheets will be correct as well. In contrast with custom software applications, which must be rigorously tested to ensure that the engineering effort has faithfully reproduced the spreadsheet's business rules, there is no need to test the calculation engine to ensure that the calculation engine is working properly since the present invention references the master spreadsheet's logic directly.

At its core, the architecture of the present invention comprises a spreadsheet with accompanying metadata repository, Internet Web server, and Extensible Markup Language (XML) serialization token. The present invention promotes the master spreadsheet to the role of software middleware, the functionality of which is exposed to remote users via a service-oriented architecture (also known as a Web service).

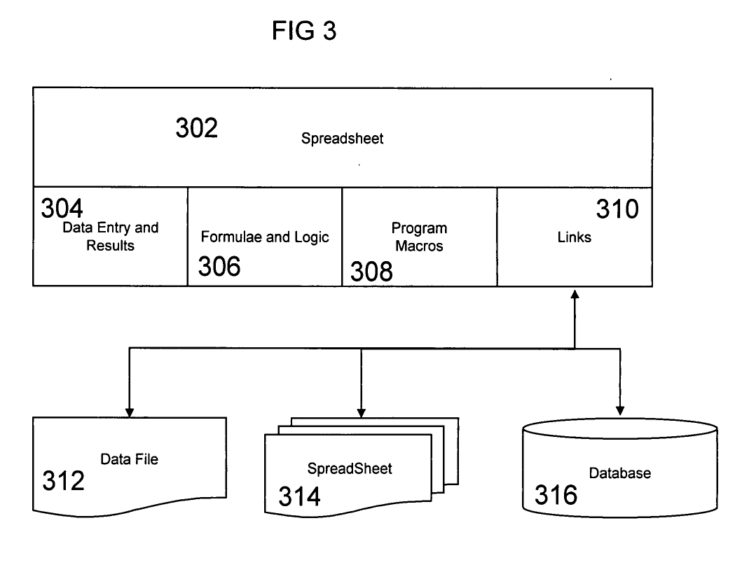

FIG. 3 is a typical user spreadsheet 302, which contains data entry cells 304, cell-level formula and logic 306, program macros 308, and links 310 to external data files 312, other spreadsheets 314, and databases 316. As described above, any changes to the formulae, logic or other parameters are straight-forward, inexpensive, and timely to implement.

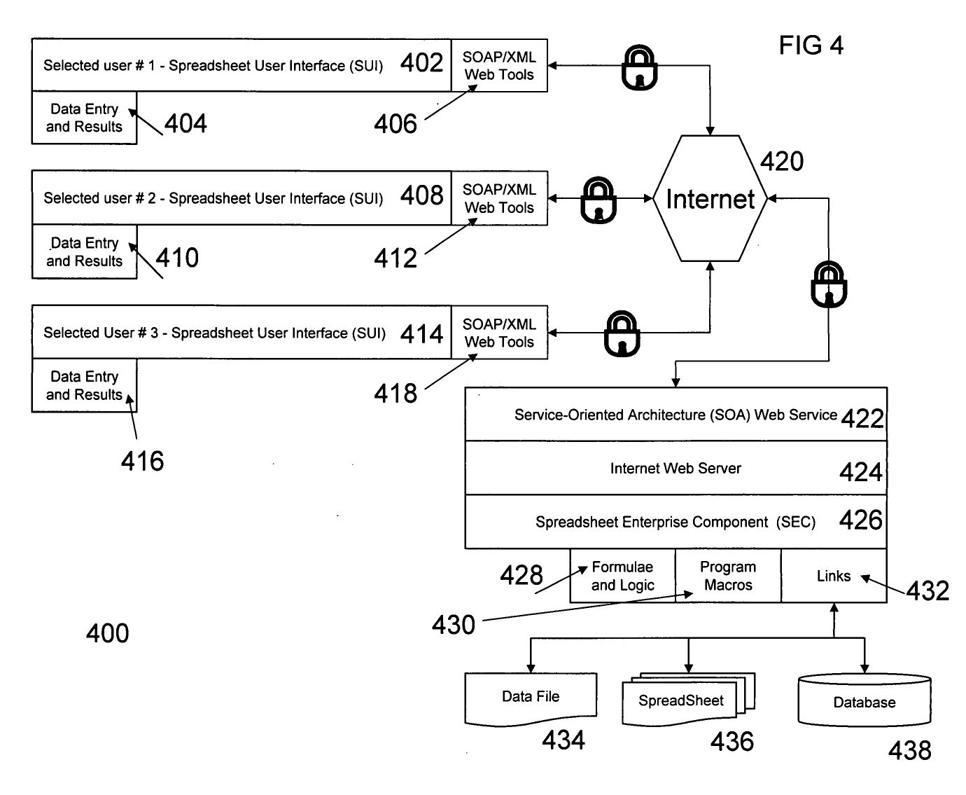

FIG. 4 depicts the remotely-controlled architecture 400 of the present invention created on software such as EXCEL® (marketed by Microsoft Corporation of Redmond, Wash.) or Open Office Calc (founded by Sun Microsystems of Santa Clara, Calif. and maintained by the OpenOffice.org Project) and which allows for easy and inexpensive changes to be implemented to the centrally-maintained formulae, logic and other parameters of the master spreadsheet. FIG. 4 displays three (3) user spreadsheets 402, 408, 414, which have been converted from typical spreadsheets to Spreadsheet User Interfaces (SUI). Instead of formulae, logic, macros and links (as present in the typical spreadsheet of FIG. 3, for example), the SUI 402, 408, 414 contain only data entry and results fields 404, 410 and 416 and the communication facility 406, 412, 418 required to consume middleware services via a secure service-oriented architecture 422 over the Inter- or corporate Intra-net 420.

As depicted in FIG. 4, the architecture 400 of the present invention further contains a master spreadsheet comprising one or more worksheets. The Spreadsheet Enterprise Component (SEC) 426 of the master spreadsheet is located remotely from the user SUI 402, 408, 414 and retains the master spreadsheet's formulae and logic 428 (including data entries, models, pricing engines, formulae, calculations, reports), Program Macros 430, and links 432 to external data files 434, other spreadsheets 436, and databases 438. As set forth in greater detail below, it is contemplated that the SEC layer 426 can be located on an internet web server 424. It is further contemplated that one or more of the worksheets within the SEC layer 426 contains one or more cells into which data is input. The master spreadsheet will also contain one or more output cells, each comprising resulting data at least partially stemming from the data placed into the input cells. Optimal design patterns of the master spreadsheet and each worksheet will depend on the industry and specific needs of the organization, manager and users.

The present invention modifies the workflows regarding distribution, collection and analysis of spreadsheet intellectual capital between and among members of a distributed workgroup while providing facilities for data production, data concurrency, data validation, data security, version control, audit trail, centralized reporting, internal control, quality control, computation, editing, and communication and many other benefits with applications to Decision Support, Business Intelligence, Data Warehousing and Regulatory Compliance.

In contrast to the typical means for distributing a master spreadsheet between and among members of a workgroup, the present invention allows the master spreadsheet to remain with the centralized source. Within the context of the present invention, the centralized source creates a copy of the master spreadsheet, and redacts (not simply protects or hides) all material non-public intellectual capital from the copy of the master spreadsheet. This copy is then distributed to one or many selected users throughout the workgroup and/or enterprise. In accordance with the present invention and as depicted within FIG. 4, one or more worksheets within the distributed copy (otherwise known as the user interface layer) of the master spreadsheet contain one or more regions of data-entry input (404, for example) comprising a spreadsheet worksheet cell or groups of cells, as well as like regions of result cells. The present invention allows for all material non-public data, formulae, and intellectual capital of the master spreadsheet to remain on a centralized server (e.g., 424) under the control of the centralized source. The selected users interact with their respective copies 402, 408, 414 of the user interface layer by entering data into the appropriate cells 404, 410, 416 at their local computers and submitting the entered data for calculation to the centrally-maintained master spreadsheet.

Using the innovation of the present invention, those same user interface layers communicate remotely with the master spreadsheet, which receives a representation of the selected users' entered data and applies the intellectual capital of the master spreadsheet to calculate a business answer according to the formulae, data and business rules of the master spreadsheet. The calculated answer is then returned to the selected user, who gains the benefit of the calculated answer without having possession of the intellectual capital within the master spreadsheet, which was redacted from the selected user's copy of the master spreadsheet.

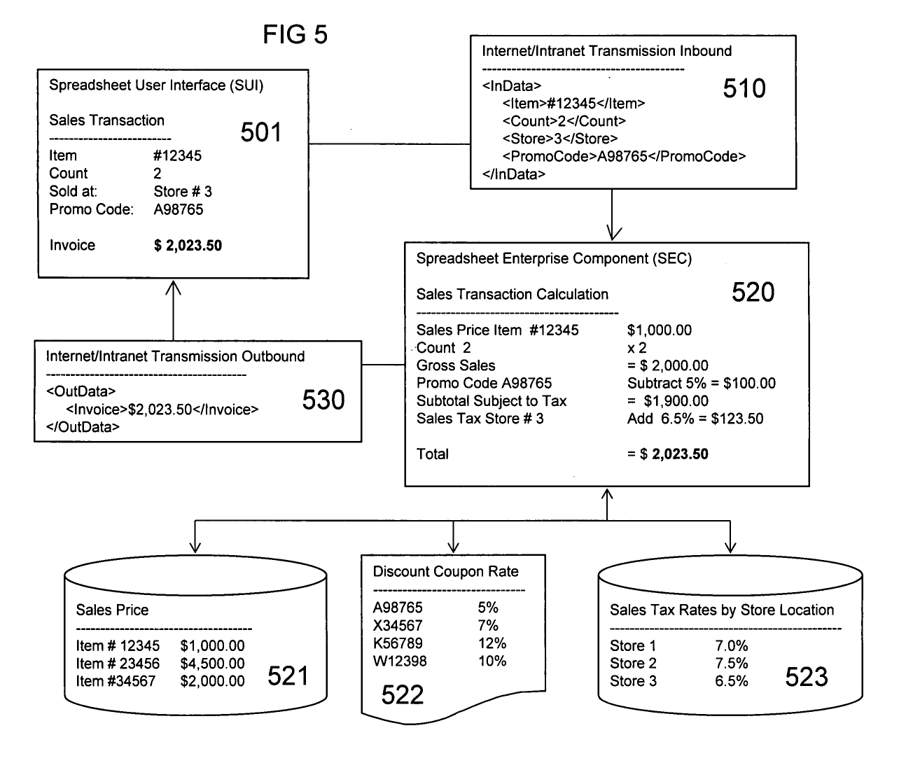

FIG. 5 provides an illustrative example. Using the innovation of the present invention, a centralized source has created a master spreadsheet that has been compiled into several components, including: 1) a Spreadsheet Enterprise Component (SEC) 520 is a copy of the master spreadsheet, and retains reference data, formulae logic, programming macros, and links to reference data and databases. The compilation process also creates a user interface layer (termed the Spreadsheet User Interface (SUI)) 501, which retains only data input and output cells, but is redacted for the master spreadsheet's reference data, formulae logic, programming macros and links to external data sources. The centralized source has placed the SUI onto, for example, a sharing server for the users to retrieve.

FIG. 5 illustrates a sales transaction using the present invention. Data is entered into the Spreadsheet User Interface (SUI) 501 denoting the Item Number, Quantity, Location, and Promotional Code for the illustrated purchase. Using the present invention, the parametric data is inserted into a standards Extensible Markup Language (XML) string and transmitted 510 over the Internet or corporate Intranet to the reporting server that hosts the Spreadsheet Enterprise Component (SEC) calculation engine 520. The SEC contains the formulae logic and links to external data sources 521, 522 and 523, and upon receipt of the incoming InData XML string, implements the sales parameters 510 to calculate the total amount due for this illustrative transaction.

FIG. 5 shows that the Spreadsheet Enterprise Component 520 selects the sales price for Item #12345 from the Sales Price database and returns one-thousand dollars ($1,000.00) 521. Two (2) of these Items #12345 were sold in this illustrative transaction, and the SEC inserts the value “2” into the proper spreadsheet cell for a gross sale transaction of $2,000.00. The customer presented a Discount Coupon with Promotional Code A98765, and the SEC requests the Discount factor for this Promo Code from the Discount Coupon Rate data lookup file 522, where the value of five percent (5%) is returned to the SEC spreadsheet and inserted into the proper spreadsheet cell. Finally, the SEC looks to the Sales Tax Rates by Store Location 523 to retrieve a sales tax factor of six and one-half percent (6.5%) for Store 3, and that value is inserted into the proper spreadsheet cell of the SEC.

The Spreadsheet User Interface (SEC) then calculates the total invoice amount 520 of two-thousand twenty-three and 50/100 dollars ($2,023.50) based on all parameters received in the InData XML string 510 and returns that value to the Spreadsheet User Interface (SUI) 501 via an OutData XML string 530. Note that the selected user's SUI has no cognition of the spreadsheet intellectual capital, business rules, formulae, or lookup data that constitute the calculation of the total invoice amount.

The present invention allows the centralized source to obtain timely, accurate reporting on the data entered by the selected users into their respective redacted copies of the master spreadsheet. The present invention renders all answers calculated by the master spreadsheet to a centrally-maintained database. Within the context of the present invention, all answers obtained by applying the intellectual property of the master spreadsheet are recorded in the centrally-maintained database as those answers are simultaneously transmitted back to the selected users' redacted copy of the master spreadsheet. The central source is therefore in immediate possession of all data input by the selected users remotely. The present invention therefore allows for data production, data concurrency, data validation, data security, version control, audit trail, centralized reporting, internal control, quality control, computation, editing, and communication and many other benefits with applications to Decision Support, Business Intelligence, Data Warehousing and Regulatory Compliance.

After the master spreadsheet is created with pre-designated input and output cells, and as described briefly above, the spreadsheet is compiled and prepared for use by the selected users. Compiling the master spreadsheet comprises creation of at least three items, including a duplicate master spreadsheet, a calculation engine (termed the Spreadsheet Enterprise Component (SEC)) and a user interface layer (termed the Spreadsheet User Interface (SUI)) and can be is initiated in various ways, including depressing a button on the spreadsheet toolbar and selection of the compilation option from a drop-down menu.

The duplicate master spreadsheet is an exact copy of the master spreadsheet and is stored in the solution repository and becomes the new working copy if changes are needed to the master spreadsheet. For example, if the master spreadsheet is created to contain sales data from various organization entities, tax rates, depreciation rates, net and gross profit and interest and the government changes the tax rate, the centralized source would access the duplicate master spreadsheet from the solution repository and incorporate the tax changes into the duplicate master spreadsheet. It is further contemplated in accordance with the present invention that instead of accessing the duplicate master spreadsheet to change one or more cells within the same, the centralized source can edit the master spreadsheet itself.

The calculation engine created during the compilation process contains the formulas and logic from the master spreadsheet and is later transferred to a reporting server, as described more below.

The user interface layer created during compilation of the master spreadsheet consists of a copy of the master spreadsheet from which the formulas and proprietary data previously inserted by the centralized source are optionally removed. This layer is intended to be distributed, published to, and eventually utilized by the end users. It is contemplated in accordance with the present invention that the centralized source creates the master spreadsheet to maintain control over the data, entries, models, pricing engines, formulas, and calculations and generally wishes to limit the components of the master spreadsheet that are viewed by the end users. It is further contemplated in accordance with the present invention that the user interface layer is a graphical user interface with which the designated end users can interact. For example, the centralized source can optionally create an aesthetically pleasing user interface layer to allow ease of data insertion. The input ranges, which are the cells visible to the end user(s), created during the master spreadsheet mapping process can be arranged to allow ease of user access and comprehension. It is also contemplated in accordance with the present invention that the centralized source can prepare the user interface layer as an Internet Web page or InfoPath template and similarly manipulate the location of the input range(s) to allow ease of access and input.

After the master spreadsheet is compiled and the duplicate master spreadsheet, Spreadsheet Enterprise Component (SEC) calculation engine and Spreadsheet User Interface (SUI) layers are created, each of the duplicate master spreadsheet, Spreadsheet Enterprise Component (SEC) calculation engine and Spreadsheet User Interface (SUI)-layers are saved onto a local location on the centralized source's computer or local or network location. It is contemplated in accordance with the present invention that the software architecture of the present invention saves the duplicate master spreadsheet, Spreadsheet Enterprise Component (SEC) calculation engine and Spreadsheet User Interface (SUI) layers onto a local directory or the hard drive of the centralized source's computer. The centralized source then determines which of these files are manually saved to the solution repository. It is contemplated that at least the duplicate master spreadsheet is saved to the solution repository, which can be configured on either a local computer or a remote server.

After the duplicate master spreadsheet, the Spreadsheet Enterprise Component (SEC) calculation engine and Spreadsheet User Interface (SUI) layer are created, compiled and saved, the centralized source optionally moves the Spreadsheet User Interface (SUI) layer to an alternate location so that it can be modified, as detailed further below.

Further, after the duplicate master spreadsheet, Spreadsheet Enterprise Component (SEC) calculation engine and Spreadsheet User Interface (SUI) layer are created, compiled and saved, the centralized source forwards the Spreadsheet Enterprise Component (SEC) calculation engine to a reporting server. Specifically, the software architecture of the present invention contains an option wherein the centralized source selects an “upload to server” option on a drop-down menu of the present invention. A Web interface within the mapping software of the present invention asks the centralized source which reporting server to be used and the electronic location of that server. Preferably, the mapping software opens a link to the reporting server Web interface when the centralized source selects the option relating to the electronic location of the calculation engine.

The reporting server of the present invention provides the Enterprise with business intelligence for User activity across the entire distributed portfolio of spreadsheet templates. Every runtime calculation submitted by each Spreadsheet User Interface (SUI) to its concomitant Spreadsheet Enterprise Component (SEC) calculation engine is saved to a database which can then be analyzed for business intelligence applications. The present invention provides synchronized spreadsheet model versioning across multiple operating entities in multiple countries and many time zones, data validation, centralized reporting, decision support, and the ability to address regulatory compliance requirements such as HIPAA, Gramm-Leach-Bliley, FERC or Sarbanes-Oxley compliance requirements. Furthermore, the present invention provides seamless and robust enterprise IT information security with rigorous internal controls and a documented audit trail. And all of these benefits are obtained at a fraction of the expense, resources and time of other options.

After the Spreadsheet Enterprise Component (SEC) calculation engine is transferred to the reporting server, the software within the reporting server protects the Spreadsheet Enterprise Component (SEC) calculation engine with an encrypted password that provides protection against outsiders viewing any material, non-public, and/or confidential information set forth on the Spreadsheet Enterprise Component (SEC) calculation engine. After the password has been added to the Spreadsheet Enterprise Component (SEC) calculation engine, the reporting server renames the Spreadsheet Enterprise Component (SEC) calculation engine from a human readable format into a hashed encrypted filename.

The reporting server also creates a manifest layer that contains information about the pairing and exchange of information between the Spreadsheet Enterprise Component (SEC) calculation engine layer and the Spreadsheet User Interface (SUI) layer. The manifest layer contains (1) an encrypted filename alias for the calculation engine (which is located on the reporting server); and (2) a date and time stamp of the last time that the calculation engine was uploaded.

The manifest layer is created and prepared as a roadmap to allow interaction and link the user Spreadsheet User Interface (SUI) layer and the Spreadsheet Enterprise Component (SEC) calculation engine. The manifest layer is never seen by or sent to the end users; rather, it is used by the centralized source during the mapping process. The reporting server requires the manifest layer to be able to link the user interface layer and the calculation engine in order to later forward data entered by the users from the user interface layer to the calculation engine and back.

To accomplish this, the manifest file is forwarded from the reporting server back to the centralized source's computer (or local/network directory). The centralized source then selects another option from the pre-installed mapping software that allows distribution. The distribution option will prompt the centralized source to select a manifest layer to pair with the user interface layer. The centralized source then selects the appropriate manifest layer, which has been previously forwarded from the reporting server to the centralized source's computer. Subsequently, the centralized source pairs the Spreadsheet User Interface (SUI) layer with the appropriate manifest layer so that the user interface layer is associated with the proper encrypted calculation engine file on the reporting server. Specifically, pairing the manifest layer with the user interface layer embeds the encrypted filename from the manifest file into the Spreadsheet User Interface (SUI) and implants the map to the reporting servers' encrypted Spreadsheet Enterprise Component (SEC) calculation engine filename into the Spreadsheet User Interface (SUI) layer so that a user's preinstalled software understands the location where the user data should be sent.

After the user Spreadsheet User Interface (SUI) and the manifest file have been paired, the centralized source uploads the Spreadsheet User Interface (SUI) file to a sharing server (such as a Sharepoint® server by Microsoft Corporation of Redmond, Wash. or other similar server common to one of ordinary skill in the art) that provides comprehensive content management, accelerates shared business processes, and preferably facilitates information-sharing. The end user(s) are then notified (via email, telephone, instant message, text message, or otherwise) that the user interface layer is prepared and ready to use. The end users are then able to download and save the Spreadsheet User Interface (SUI) file from the sharing server onto the User's own computer or other accessible database, server or folder.

After downloading and saving the Spreadsheet User Interface (SUI) layer from the sharing server, the end users are able to insert data into the pre-determined input range(s) on the Spreadsheet User Interface (SUI) layer using standard spreadsheet data-entry techniques. After data entry, the end user then optionally re-saves the Spreadsheet User Interface (SUI) layer into a folder, database, server or other electronic location either on the end user's computer or another electronic location to which the end user has access.

After the end user(s) locates and downloads the Spreadsheet User Interface (SUI) layer from the sharing server and inputs the relevant data into the input ranges within the Spreadsheet User Interface (SUI) layer, the end user can initiate an automated, indirect interaction between the Spreadsheet User Interface (SUI) layer and the centralized source. The interaction is automated by pressing a button on the toolbar of the user's computer or selecting the automate option on a drop-down menu, both of which are part of pre-installed user tools/software and is performed to allow the end user to receive reports and other data from the calculation engine.

Selecting the automation option on a user's computer initiates a several-step process beginning with the creation of an extensible markup language (XML) file. An XML file is generally classified as extensible because it allows its creators and users to define their own elements. Its primary purpose is to facilitate the sharing of structured data across different information systems, particularly via the Internet, and it is used both to encode documents and to serialize data.

In the architecture of the present invention, the XML File stemming from the Spreadsheet User Interface (SUI) layer contains metadata that allows communication between the data within the Spreadsheet User Interface (SUI) layer and the formulas and other information within the Spreadsheet Enterprise Component (SEC) calculation engine. After creation, the XML file is encrypted and uploaded from the user's Spreadsheet User Interface (SUI) layer onto the reporting server via extensible markup language over hypertext transfer protocol (XML over HTTP). On the way from the user's computer to the reporting server, the XML file contains InData, which are the data from the Spreadsheet User Interface (SUI) input ranges that are submitted by the reporting server to the Spreadsheet Enterprise Component (SEC) and are used to generate reports to be sent back to the end user and information relating to the identity of the paired file.

After receipt, the reporting server decrypts the XML file and interprets the data within the XML file to allow the reporting server to pair the InData from the XML file with the manifest layer and its corresponding calculation engine. The calculator within the reporting server then inserts the InData from the XML file into the encrypted calculation engine.

The reporting server then creates a new XML file containing both the InData and OutData, which are the appropriate reports based on the user data and the information (including formulas and other data) from the Spreadsheet Enterprise Component (SEC) calculation engine. The new XML file is then encrypted and transmitted back to the user's workstation where they can be viewed, printed and otherwise utilized.

The software of the present invention then decodes the encrypted XML file to allow the end user to view the reports that are transferred back to the Spreadsheet User Interface (SUI). The reports are rendered in the same Spreadsheet User Interface (SUI) spreadsheet file on which the end user was inputting data. It is contemplated in accordance with the present invention that, while the end user initiates the automation option on its computer, the end user may not realize that the data contained within its user interface layer is being transmitted to the reporting server which allows the end user to receive the aforementioned reports. Furthermore, it is contemplated that the time by which the user interface layer is automated, forwarded to the reporting server, manipulated and reports returned to the end user depends on the amount of data being transferred and the speed of the user's internet connection; however, it is contemplated in accordance with the present invention that the automation process takes from about one-half (0.5) second to about 60 seconds, depending on the size of the XML object brokered by the services-oriented architecture.

In another embodiment of the present invention, if a parameter, such as a tax rate, interest rate, discount rate, or physical constant that is expressed within one or more formulas within the master spreadsheet should change, the centralized source can modify the master spreadsheet or the duplicate master spreadsheet (located on the solution repository) to accurately contain this new rate. Then, the centralized source re-compiles the master spreadsheet, which will create a new Spreadsheet Enterprise Component (SEC) calculation engine that is then loaded to the reporting server. The reporting server replaces the existing Spreadsheet Enterprise Component (SEC) calculation engine with the new Spreadsheet Enterprise Component (SEC) calculation engine on the server and the new Spreadsheet Enterprise Component (SEC) calculation engine is updated, renamed, protected and encrypted on the reporting server.

However, instead of creating revised user interface and manifest layers, the centralized source will be asked by the software of the present invention if a manifest layer already exists relating to the master spreadsheet. Since, in this embodiment of the present invention, the master spreadsheet was previously created and later modified, the centralized source can pair the revised calculation engine to the previously-created manifest layer by selecting the file name of the previous manifest layer. Then, when an end user inputs data and automates its user interface layer (using the pre-installed user software), the XML stream from the user interface layer will link to the revised calculation engine (since the user interface layer and the revised calculation engine are both paired to the single manifest layer). In fact, the end user does not (and need not) know that the calculation engine formulas, reference data, and/or parameters have changed. Instead, the end user simply requests automation of the user interface layer (by depressing or selecting the appropriate tool bar or menu option) and accurate reports will be generated by the reporting server of the present invention, regardless of whether the master spreadsheet is the same or modified format compared to when the user initially accessed the interface layer.

Another aspect of the present invention is that the reporting server can be connected to a secondary server, such as Microsoft's Structured Query Language (SQL) server. The information uploaded onto the reporting server from the selected users can be encrypted and transferred to the secondary server. Among other things, the centralized source can then request reports from the secondary server regarding types of inputs that are uploaded from various selected users over various periods of time. This will allow the centralized source to see trends and assist in budgeting, planning and in various other ways.

The architecture of the present invention enables a distributed workgroup to share spreadsheets across the business domain, which allows a centralized data repository, a familiar spreadsheet interface, version control, an audit trail, data concurrency, information security, internal control, quality control, retained control over rule changes and allows selected users to view only the reports that are only the information to their workgroup.

The architecture of the present invention also allows business subject-matter experts and executive sponsors to maintain sovereignty over the master spreadsheet and its models, pricing engines, formulas and calculations. The master spreadsheet model need not be surrendered to central IT departments or outside consultants to be re-engineered in a less nimble solution. Furthermore, spreadsheets can be mounted directly onto the platform of the present invention and retain their original format while gaining robust information security, database, and analysis capabilities in the process.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A centralized computer architecture comprising an electronic grid-based calculator and allowing data transfer to and from one or more remote users and a centralized source using the grid-based calculator as middleware.

2. The centralized computer architecture of claim 1, wherein the centralized source compiles the data set forth within the electronic grid-based calculator.

3. The centralized computer architecture of claim 2, wherein the data compilation prepares a calculation engine and a user interface layer.

4. The centralized computer architecture of claim 3, wherein the calculation engine comprises a service-oriented architecture that exposes middleware services to the remote users.

5. The centralized computer architecture of claim 3, wherein the user interface layer is transmitted onto a sharing server.

6. The centralized computer architecture of claim 5, wherein the one or more users access the user interface layer via the sharing server.

7. The centralized computer architecture of claim 6, wherein the one or more users add data to their respective copies of the user interface layer, at least a portion of which is transmitted to a report server.

8. The centralized computer architecture of claim 7, wherein the portion of the user interface layer that is transmitted is an XML stream.

9. A computer architecture comprising an electronic grid-based calculator, a report server, a sharing server, and a user interface layer.

10. The computer architecture of claim 9, further comprising a calculation engine.

11. The computer architecture of claim 10, further comprising a manifest layer.

12. The computer architecture of claim 11, wherein the manifest layer comprises the secure filename of the calculation engine.

13. The computer architecture of claim 9, wherein the user interface layer is electronically stored on the sharing server and the calculation engine is electronically stored on the report server.

14. The computer architecture of claim 12, wherein the manifest layer is paired with the user interface layer.

15. The computer architecture of claim 14, wherein one or more end users retrieve the user interface layer from the sharing server.

16. The computer architecture of claim 15, wherein a subset or all of the retrieved user interface layer is revised and transmitted to the report server, wherein the calculation engine analyzes the subset and returns one or more reports to the one or more end users.

17. The computer architecture of claim 11, wherein the electronic grid-based calculator is amended and compiled, thereby revising the calculation engine stored on the report server.

18. The computer architecture of claim 17, wherein the amended calculation layer does not require production of a new manifest layer.

19. The computer architecture of claim 18, wherein the one or more end users can further revise the user interface layer and transmit a subset or all of the revised user interface layer to the report server, wherein the amended calculation layer analyzes the subset and returns one or more reports to the one or more end users without requiring that the end user become aware that the calculator or calculation layer has been amended.
